(19) United States
(12) Patent Application Publication
(10) Pub. No.: US 2023/0121641 A1
(43) Pub. Date: Apr. 20, 2023

(54) DIELECTRIC RESONATOR ANTENNA AND ANTENNA MODULE

(71) Applicant: Samsung Electro-Mechanics Co., Ltd., Suwon-si (KR)

(72) Inventors: Woncheol LEE, Suwon-si (KR); Wongi KIM, Suwon-si (KR); Jeongki RYOO, Suwon-si (KR); Won Wook SO, Suwon-si (KR); Gilha LEE, Suwon-si (KR); Sungyong AN, Suwon-si (KR)

(73) Assignee: Samsung Electro-Mechanics Co., Ltd., Suwon-si (KR)

(21) Appl. No.: 17/957,648

(22) Filed: Sep. 30, 2022

(30) Foreign Application Priority Data
Oct. 15, 2021 (KR) 10-2021-0137777

(51) Int. Cl. H01Q 9/04; H01Q 1/50

(52) U.S. Cl. CPC H01Q 9/0485; H01Q 1/50

(57) ABSTRACT

A dielectric resonator antenna includes a dielectric material block extending in a first direction, a second direction different from the first direction, and a third direction perpendicular to the first direction and the second direction; and a feeding part extending in the third direction from a bottom surface of the dielectric material block to a part of the dielectric material block, wherein the feeding part overlaps a diagonal, or an extension line of the diagonal, of the bottom surface of the dielectric material block intersecting a first position where a first edge of the bottom surface of the dielectric material block parallel to the first direction and a second edge of the bottom surface of the dielectric material block parallel to the second direction meet.

### CROSS-REFERENCE TO RELATED APPLICATIONS

This application claims the benefit under 35 USC 119(a) of Korean Patent Application No. 10-2021-01 37777 filed on Oct. 15, 2021, in the Korean Intellectual Property Office, the entire contents of which are incorporated herein by reference for all purposes.

### BACKGROUND

### 1. Field

This application relates to a dielectric resonator antenna and an antenna module.

### 2. Description of Related Art

The development of wireless communication systems has greatly changed lifestyles over the past 20 years. An advanced mobile system with a gigabit per second data speed is required to support potential wireless applications such as multimedia devices, Internet of Things, and intelligent transportation systems. This is impossible to achieve in a current 4G communication system due to a limited bandwidth. To overcome the bandwidth limitation, the International Telecommunication Union has allocated a millimeter wave (mmWave) spectrum for a 5G application range of a potential 5G generation. Since then, there has been a lot of interest in research on mmWave antennas in both academia and industry.

Recently, a need has arisen for a downsized mmWave 5G antenna module for a mobile phone. Considering a radiation characteristic, since the 5G antenna is located on the outermost side of the mobile phone, the length of one side of the antenna module is gradually decreasing in the structure of a mobile phone with a larger screen and a thinner case.

As the antenna module size decreases, performance such as an antenna gain and a bandwidth may deteriorate.

The above information disclosed in this Background section is only for enhancement of understanding of the background of the described technology, and therefore it may contain information that does not constitute prior art that is already known in this country to a person of ordinary skill in the art.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a dielectric resonator antenna includes a dielectric material block extending in a first direction, a second direction different from the first direction, and a third direction perpendicular to the first direction and the second direction; and a feeding part extending in the third direction from a bottom surface of the dielectric material block to a part of the dielectric material block, wherein the feeding part overlaps a diagonal, or an extension line of the diagonal, of the bottom surface of the dielectric material block intersecting a first position where a first edge of the bottom surface of the dielectric material block parallel to the first direction and a second edge of the bottom surface of the dielectric material block parallel to the second direction meet.

A distance between the first position and the feeding part may be smaller than a distance between a center of the first edge of the bottom surface of the dielectric material block and the feeding part, and the feeding part may be closer to the first position than to a center of the bottom surface of the dielectric material block.

The feeding part may include a feed via extending inside the dielectric material block in the third direction from the bottom surface of the dielectric material block.

The feeding part may include a feed strip extending along an outer surface of the dielectric material block in the third direction from the bottom surface of the dielectric material block.

The feed strip may touch the first position and extend in the third direction along a corner of the dielectric material block extending in the third direction.

The dielectric material block may include a first dielectric material block, a second dielectric material block stacked on the first dielectric material block in the third direction, and a bonding layer disposed between the first dielectric material block and the second dielectric material block, a bottom surface of the first dielectric material block may be the bottom surface of the dielectric material block, and the feeding part may extend in the third direction from the bottom surface of the first dielectric material block to a part of the first dielectric material block.

The dielectric resonator antenna may further include a feed pattern disposed between the first dielectric material block and the second dielectric material block and connected to the feeding part; and an antenna pattern disposed between the first dielectric material block and the second dielectric material block and coupled to the feed pattern.

The feeding part may include a feed via extending completely through the first dielectric material block in the third direction from the bottom surface of the dielectric material block, and the feed pattern may be connected to the feed via.

The feeding part may include a feed strip extending along an outer surface of the first dielectric material block in the third direction from the bottom surface of the first dielectric material block, and the feed pattern may be connected to the feed strip.

In another general aspect, a dielectric resonator antenna module includes a substrate; and a plurality of dielectric resonator antennas disposed on the substrate, wherein each of the plurality of dielectric resonator antennas includes a dielectric material block extending in a first direction, a second direction different from the first direction, and a third direction perpendicular to the first direction and the second direction; and a feeding part extending in the third direction from a bottom surface of the dielectric material block to a part of the dielectric material block, wherein the feeding part overlaps a diagonal, or an extension line of the diagonal, of the bottom surface of the dielectric material block intersecting a first position where a first edge of the bottom surface of the dielectric material block parallel to the first direction and a second edge of the bottom surface of the dielectric material block parallel to the second direction meet, and the plurality of dielectric resonator antennas are disposed on the substrate along a line extending in a fourth direction.

A distance between the first position and the feeding part may be smaller than a distance between a center of the first edge and the feeding part, and the feeding part may be closer to the first position than to a center of the bottom surface of the dielectric material block.

The diagonal of the bottom surface of the dielectric material block may be parallel to the fourth direction.

The feeding parts of the plurality of dielectric resonator antennas may be disposed along a line extending in the fourth direction.

The diagonals of the bottom surfaces of the plurality of dielectric resonator antennas may be substantially perpendicular to the fourth direction.

The feeding parts of the plurality of dielectric resonator antennas may be disposed along a line extending in the fourth direction.

Angles between the diagonals of the bottom surfaces of the plurality of dielectric resonator antennas and the fourth direction may be less than 90 degrees.

The feeding parts of the plurality of dielectric resonator antennas may be disposed along a line extending in the fourth direction.

In another general aspect, a dielectric resonator antenna includes a dielectric material block extending in a first direction, a second direction different from the first direction, and a third direction perpendicular to the first direction and the second direction; and a feeding part contacting the dielectric material block and extending in the third direction, wherein the feeding part is closer to a first position where a first edge of a bottom surface of the dielectric material block parallel to the first direction meets a second edge of the bottom surface of the dielectric material block parallel to the second direction than to a center of the first edge of the bottom surface of the dielectric material block, a center of the second edge of the bottom surface of the dielectric material block, and a center of the bottom surface of the dielectric material block.

The second direction may be perpendicular to the first direction, the dielectric material block may have six surfaces, and each of the six surfaces may be a square or a rectangle.

The feeding part may include a feed via disposed inside the dielectric material block and extending in the third direction.

The feed via may extend in the third direction from the bottom surface of the dielectric material block and may overlap a diagonal of the bottom surface of the dielectric material block intersecting the first position.

The feeding part may include a feed strip disposed on an outside surface of the dielectric material block and extending in the third direction.

A bottom surface of the feed strip may touch the first position and may overlap an extension line of a diagonal of the bottom surface of the dielectric material block intersecting the first position, and the feed strip may extend in the third direction along a corner of the dielectric material block extending in the third direction and may overlap two surfaces of the dielectric material block meeting at the corner.

Other features and aspects will be apparent from the following detailed description, the drawings, and the claims.

### BRIEF DESCRIPTION OF DRAWINGS

FIG. 1 is a perspective view of a dielectric resonator antenna according to an embodiment.

FIG. 2 is a top plan view of the dielectric resonator antenna of FIG. 1.

FIG. 3 is a perspective view of a dielectric resonator antenna according to a conventional art.

FIG. 4 is a perspective view of a dielectric resonator antenna according to another embodiment.

FIG. 5 is a top plan view of the dielectric resonator antenna of FIG. 4.

FIG. 6 is a perspective view of a dielectric resonator antenna according to another embodiment.

FIG. 7 is a top plan view of the dielectric resonator antenna of FIG. 6.

FIG. 8 is a cross-sectional view of the dielectric resonator antenna of FIG. 6.

FIG. 9 is a view showing a manufacturing method of a dielectric resonator antenna according to an embodiment.

FIG. 10 is a perspective view of a dielectric resonator antenna according to another embodiment.

FIG. 11 is a top plan view of the dielectric resonator antenna of FIG. 10.

FIG. 12 is a perspective view of a dielectric resonator antenna according to another embodiment.

FIG. 13 is a top plan view of the dielectric resonator antenna of FIG. 12.

FIG. 14 is a perspective view of a dielectric resonator antenna according to another embodiment.

FIG. 15 is a top plan view of the dielectric resonator antenna of FIG. 14.

FIG. 16 is a perspective view of an antenna module including a plurality of dielectric resonator antennas according to an embodiment.

FIG. 17 is a cross-sectional view of the antenna module of FIG. 16.

FIG. 18 is a top plan view of the antenna module of FIG. 16.

FIG. 19 is a top plan view of an antenna module according to another embodiment.

FIG. 20 is a top plan view of an antenna module according to another embodiment.

FIG. 21 is a top plan view of an antenna module according to another embodiment.

FIG. 22 is a top plan view of an antenna module according to another embodiment.

FIG. 23 is a top plan view of an antenna module according to another embodiment.

FIG. 24 is a view showing an electronic device including a dielectric resonator antenna module according to an embodiment.

FIG. 25 is a view showing an electronic device including a dielectric resonator antenna according to another embodiment.

FIG. 26 is a view showing an electronic device including a dielectric resonator antenna module according to another embodiment.

FIG. 27 and FIG. 28 are graphs showing results of an experimental example.

FIG. 29 and FIG. 30 are views showing results of another experimental example.

FIG. 31 and FIG. 32 are graphs showing results of another experimental example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the specification, a pattern, a via, a plane, a line, and an electrical connection structure may include a metal material (for example, a conductive material of copper (Cu), aluminum (Al), silver (Ag), tin (Sn), gold (Au), nickel (Ni), lead (Pb), titanium (Ti), or alloys thereof, and may be formed by a plating method such as Chemical Vapor Deposition (CVD), Physical Vapor Deposition (PVD), sputtering, a subtractive process, an additive process, a Semi-Additive Process (SAP), or a Modified Semi-Additive Process (MSAP), but is not limited thereto.

Throughout the specification, a dielectric layer and/or insulation layer may be implemented as FR4, Liquid Crystal Polymer (LCP), Low Temperature Co-fired Ceramic (LTCC), thermosetting resins such as epoxy resins, thermoplastic resins such as polyimide, or materials in which these resins are impregnated into core materials such as glass fibers (Glass Fiber, Glass Cloth, Glass Fabric) together with inorganic fillers, pre-preg, Ajinomoto Build-up Film (ABF), Bismaleimide Triazine (BT), Photo-Imageable Dielectric (PID) resins, Copper Clad Laminate (CCL), or insulating materials of glass or ceramic series.

Throughout the specification, a RF (Radio Frequency) signal may have a format according to Wi-Fi (IEEE 802.11 family, etc.), WiMAX (IEEE 802.16 family, etc.), IEEE 802.20, LTE (long term evolution), Ev-DO, HSPA, HSDPA, HSUPA, EDGE, GSM, GPS, GPRS, CDMA, TDMA, DECT, Bluetooth, 3G, 4G, 5G, and other arbitrary wireless and wired protocols designated later, but is not limited thereto.

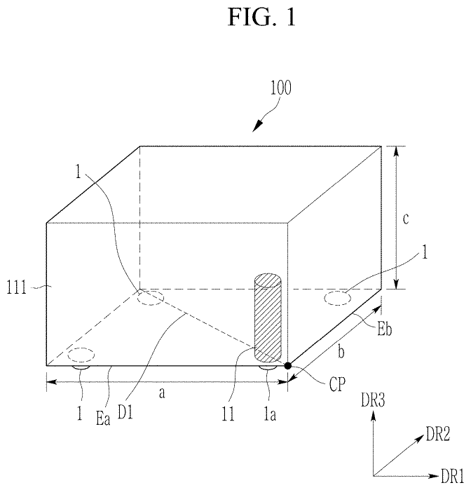

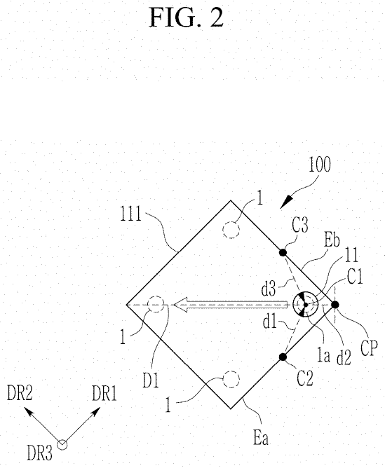

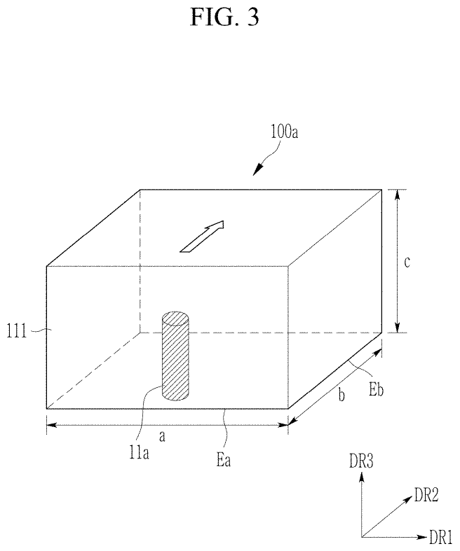

A dielectric resonator antenna 100 according to an embodiment is described with reference to FIG. 1 and FIG. 2. FIG. 1 is a perspective view of a dielectric resonator antenna according to an embodiment, and FIG. 2 is a top plan view of the dielectric resonator antenna of FIG. 1. FIG. 3 is a perspective view of a dielectric resonator antenna according to a conventional art.

Referring to FIG. 1 and FIG. 2, a dielectric resonator antenna (DRA) 100 according to an embodiment may include a dielectric material block 111 having a shape extending in a first direction DR1 and a second direction DR2 different from each other, and a third direction DR3 perpendicular to the first direction DR1 and the second direction DR2, a feed via 11 disposed inside the dielectric material block 111, and a plurality of connection parts 1 and 1a disposed under the dielectric material block 111, that is, attached to the bottom surface of the dielectric material block 111.

The dielectric material block 111 may have a rectangular parallelepiped shape, for example, and the dielectric material block 111 may have a via hole into which the feed via 11 is inserted.

The dielectric material block 111 may have the rectangular parallelepiped shape having a first length a in the first direction DR1, a second length b in the second direction DR2, and a third length c in the third direction DR3.

The feed via 11 may be disposed extending in the third direction DR3 within a portion of the dielectric material block 111.

The feed via 11 may be disposed adjacent to a first position CP formed by a meeting of a first edge Ea parallel to the first direction DR1 and a second edge Eb parallel to the second direction DR2 on the bottom surface of the dielectric material block 111.

With reference to the bottom surface of the dielectric material block 111, a first center C1 of the feed via 11 may overlap a diagonal D1 of the bottom surface of the dielectric material block 111 intersecting the first position CP. In addition, with reference to the bottom surface of the dielectric material block 111, the first center C1 of the feed via 11 may be disposed closer to the first position CP than a center of the bottom surface of the dielectric material block 111.

With reference to the bottom surface of dielectric material block 111, a first interval d1 between the first center C1 of the feed via 11 and a second center C2 of the first edge Ea may be greater than a second interval d2 between the first center C1 of the feed via 11 and the first position CP, and similarly, a third interval d3 between the first center C1 of the feed via 11 and a third center C3 of the second edge Eb may be greater than the second interval d2 between the first center C1 of the feed via 11 and the first position CP.

As such, by disposing the feed via 11 so that the first center C1 of the feed via 11 overlaps the diagonal D1 of the bottom surface of the dielectric material block 111 intersecting the first position CP as indicated by the arrow in FIG. 2, the main direction of the electric field distribution generated on the upper surface of the dielectric material block 111 may be parallel to the diagonal D1.

Like an antenna 100a according to a conventional art shown in FIG. 3, compared with a case that the feed via 11 is disposed close to the second center C2 of the first edge Ea of the dielectric material block 111 or the third center C3 of the second edge Eb, the distribution length of the electric field generated by the electric signal applied from the feed via 11 may be increased. Therefore, compared to the antenna 100a according to the conventional art, it is possible to increase the gain of the antenna 100 without increasing the first length a and the second length b of the dielectric material block 111.

When the electric signal is applied to the feed via 11, a resonance of a predetermined frequency occurs inside the dielectric material block 111, and an RF signal may be transmitted and received according to the resonance frequency of the antenna 100.

When the resonance frequency of the antenna 100 according to the present embodiment is constant, the size of the antenna 100 is proportional to (e)^{-1/2} when a specific dielectric constant value of the dielectric material block 111 is e. Therefore, if the specific dielectric constant value of the dielectric material block 111 is increased, the size of the antenna 100 can be reduced.

The dielectric material block 111 of the antenna 100 according to the present embodiment may have a large dielectric constant, for example, may have a dielectric constant of 1 or more, and more specifically 10 or more.

A plurality of via holes may be formed in the dielectric layer constituting the dielectric material block 111 to form a plurality of feed vias 11, and then a plurality of dielectric resonator antennas 100 may be collectively manufactured by cutting the dielectric layer into the individual dielectric resonator antennas 100.

A plurality of connection parts 1 and 1a may include an electrical connecting member such as a solder ball.

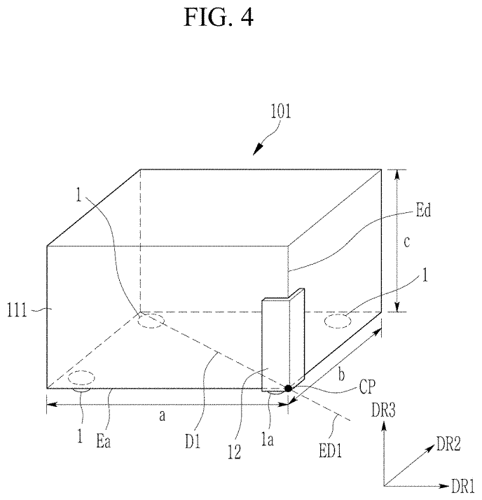

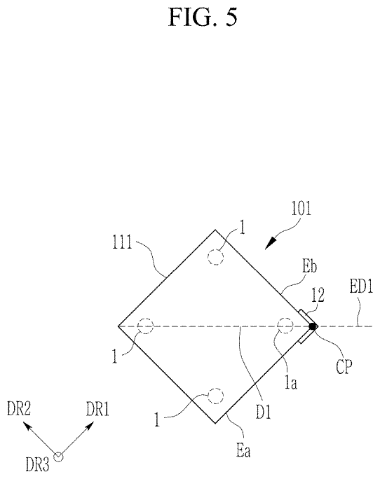

A dielectric resonator antenna 101 according to another embodiment is described with reference to FIG. 4 and FIG. 5. FIG. 4 is a perspective view of a dielectric resonator antenna according to another embodiment, and FIG. 5 is a top plan view of the dielectric resonator antenna of FIG. 4.

Referring to FIG. 4 and FIG. 5, the dielectric resonator antenna 101 according to the present embodiment, similar to the dielectric resonator antenna 100 according to the embodiment described with reference to FIG. 1 and FIG. 2, may include a dielectric material block 111 having a shape extending in the first direction DR1, the second direction DR2, and the third direction DR3 perpendicular to the first direction DR1 and the second direction DR2, a feed strip 12 disposed on an outside surface of the dielectric material block 111, and a plurality of connection parts 1 and 1a disposed under the dielectric material block 111, that is, attached to the bottom surface of the dielectric material block 111.

The dielectric material block 111 may have a rectangular parallelepiped shape, for example, and the feed strip 12 disposed on the outside surface of the dielectric material block 111 may be a feeding unit of the antenna 101.

The dielectric material block 111 may have a rectangular parallelepiped shape having a first length a in the first direction DR1, a second length b in the second direction DR2, and a third length c in the third direction DR3.

The feed strip 12 may be disposed on a first corner Ed of the dielectric material block 111 extending in the third direction DR3 from the first position CP formed by the meeting of the first edge Ea parallel to the first direction DR1 and the second edge Eb parallel to the second direction DR2 on the bottom surface of the dielectric material block 111. The feed strip 12 may touch the first position CP formed by the meeting of the first edge Ea parallel to the first direction DR1 and the second edge Eb parallel to the second direction DR2 on the bottom surface of the dielectric material block 111.

With reference to the bottom surface of the dielectric material block 111, the feed strip 12 may overlap an extension line ED1 of the diagonal D1 of the bottom surface of the dielectric material block 111 intersecting the first position CP.

As such, by disposing the feed strip 12 so as to overlap the extension line ED1 of the diagonal D1 of the bottom surface of the dielectric material block 111 intersecting the first position CP, compared to the case of disposing the feed strip 12 adjacent to the second center C2 of the first edge Ea of the dielectric material block 111 or the third center C3 of the second edge Eb, the distribution length of the electric field generated by the electric signal applied from the feed strip 12 may be increased. Through this, the gain of the antenna 101 may be increased.

Many features of the antenna 100 according to the embodiment previously described with reference to FIG. 1 and FIG. 2 are applicable to the dielectric resonator antenna 101 according to the present embodiment.

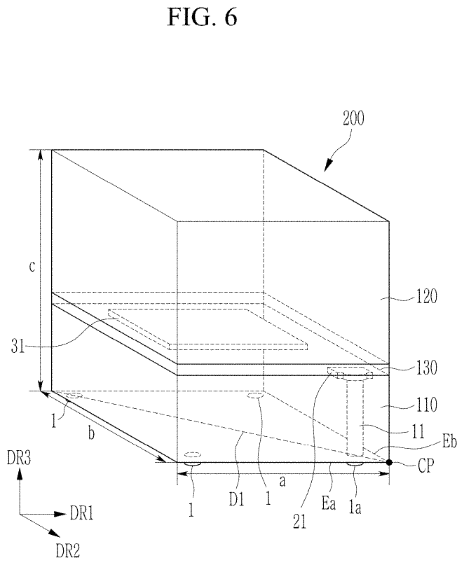

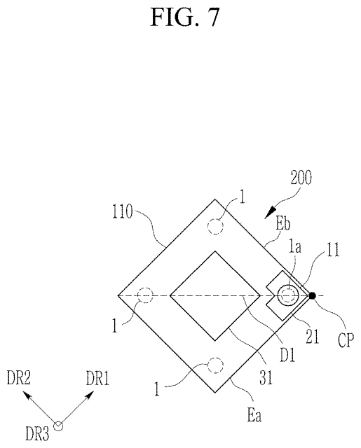

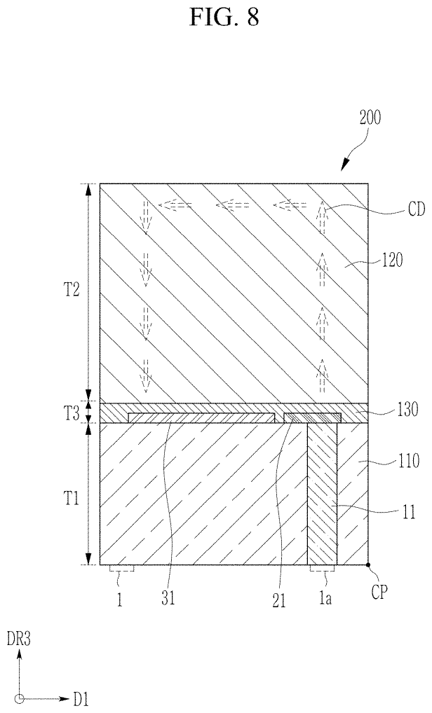

A dielectric resonator antenna 200 according to another embodiment is described with reference to FIG. 6 to FIG. 8. FIG. 6 is a perspective view of a dielectric resonator antenna according to another embodiment, FIG. 7 is a top plan view of the dielectric resonator antenna of FIG. 6, and FIG. 8 is a cross-sectional view of the dielectric resonator antenna of FIG. 6.

Referring to FIG. 6 to FIG. 8, a dielectric resonator antenna 200 according to the present embodiment includes a first dielectric material block 110 and a second dielectric material block 120 stacked in the third direction DR3, a bonding layer 130 disposed between the first dielectric material block 110 and the second dielectric material block 120, a feed via 11 inserted in the first dielectric material block 110, a feed pattern 21 and an antenna patch 31 disposed between the first dielectric material block 110 and the second dielectric material block 120, and a plurality of connection parts 1 and 1a disposed under the first dielectric material block 110, that is, attached to the bottom surface of the first dielectric material block 110.

The first dielectric material block 110 and the second dielectric material block 120 may have a shape extending in the first direction DR1 and the second direction DR2 different from each, and the third direction DR3 that is perpendicular to the first direction DR1 and the second direction DR2, and the first dielectric material block 110 and the second dielectric material block 120 are stacked on each other with the bonding layer 130 interposed therebetween in the third direction DR3.

The first dielectric material block 110 may have a rectangular parallelepiped shape, for example, and the first dielectric material block 110 may have a via hole into which the feed via 11 is inserted. The feed via 11 may penetrate from the lower surface to the upper surface of the first dielectric material block 110 in the third direction DR3. However, the feed via 11 may be disposed within a portion of the first dielectric material block 110 in the third direction DR3.

The feed via 11 is disposed adjacent to the first position CP formed by the meeting of the first edge Ea parallel to the first direction DR1 and the second edge Eb parallel to the second direction DR2 on the bottom surface of the first dielectric material block 110.

With reference to the bottom surface of the first dielectric material block 110, the first center C1 of the feed via 11 may overlap the diagonal D1 of the bottom surface of the first dielectric material block 110 intersecting the first position CP.

As such, by disposing the feed via 11 so that the first center C1 of the feed via 11 overlaps the diagonal D1 of the bottom surface of the first dielectric material block 110 intersecting the first position CP, a maximum interval between the feed via 11 and the positions, except for the first position CP, where two edges of the bottom surface of the first dielectric material block 110 extending in different directions intersect each other may be increased. Through this, the gain of the antenna 200 may be increased.

The second dielectric material block 120 may have a rectangular parallelepiped shape, for example.

The first dielectric material block 110 and the second dielectric material block 120 may have the same planar shape to overlap each other in the third direction DR3. Therefore, when the first dielectric material block 110 and the second dielectric material block 120 are laminated and bonded to each other in the third direction DR3 through the bonding layer 130, each of the sides, i.e., four pairs of the sides may be smoothly connected to each other without a step so as to be respectively coplanar. However, on one plane formed by the intersection of the first direction DR1 and the second direction DR2, the plane area of the bonding layer 130 may be smaller than the plane area of the first dielectric material block 110 and the second dielectric material block 120.

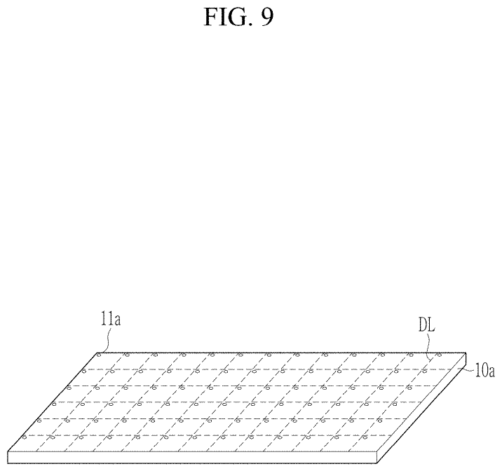

A manufacturing method of the dielectric resonator antenna according to an embodiment will be described with reference to FIG. 9. FIG. 9 is a view showing a manufacturing method of a dielectric resonator antenna according to an embodiment. As shown in FIG. 9, a plurality of via holes 11a may be drilled in the dielectric layer 10a constituting the first dielectric material block 110, and a conducting material may be filled in the plurality of via holes 11a. Next, after forming a plurality of feed patterns 21 and a plurality of antenna patches 31 on the dielectric layer 10a, a second dielectric layer constituting a second dielectric material block 120 is disposed on the first dielectric layer, a polymer layer constituting a bonding layer is disposed and cured between the first dielectric layer and the second dielectric layer position to bond the first dielectric layer and the second dielectric layer, and the first dielectric layer and the second dielectric layer bonded to each other are cut for each antenna unit like a dividing line DL shown in FIG. 9, thereby collectively manufacturing a plurality of dielectric resonator antennas 200. As such, by collectively manufacturing the plurality of dielectric resonator antennas 200, in the dielectric resonator antenna 200, the first dielectric material block 110 and the second dielectric material block 120 are stacked in the third direction DR3, and each of the side surfaces, that is, four pairs of the side surfaces may be formed to be smoothly connected to each other without a step difference so as to be disposed on the same plane, respectively.

Referring to FIG. 8, the thickness of the first dielectric material block 110 and the thickness of the second dielectric material block 120 measured in the third direction DR3 may be different from each other. For example, the second thickness T2 of the second dielectric material block 120 may be thicker than the first thickness T1 of the first dielectric material block 110.

The bonding layer 130 may have adherence to bond the first dielectric material block 110 and the second dielectric material block 120 to each other. In addition, the bonding layer 130 includes a material that may be cured, and is cured between the first dielectric material block 110 and the second dielectric material block 120, and the first dielectric material block 110 and the second dielectric material block 120 may be bonded to each other through the bonding layer 130.

The third thickness T3 of the bonding layer 130 measured in the third direction DR3 may be thinner than the first thickness T1 of the first dielectric material block 110 and the second thickness T2 of the second dielectric material block 120 measured in the third direction DR3.

The feed pattern 21 and the antenna patch 31 may be disposed between the first dielectric material block 110 and the bonding layer 130, and the feed pattern 21 and antenna patch 31 are disposed to be spaced apart from each other on a plane formed by the intersection of the first direction DR1 and the second direction DR2.

For example, in the third direction DR3, the feed pattern 21 and the antenna patch 31 may be disposed on the first dielectric material block 110, and the bonding layer 130 may be disposed on the first dielectric material block 110, the feed pattern 21 and the antenna patch 31.

The feed pattern 21 may have a planar shape of a rectangle or a square, for example, and may have a smaller plane area than that of the first dielectric material block 110.

The feed pattern 21 may be fed from the feed via 11. That is, the feed via 11 may be a feeding unit of the antenna 200. In the illustrated embodiment, the feed pattern 21 may be disposed above the feed via 11 in the third direction DR3 in contact with the feed via 11.

The antenna patch 31 is coupled by being spaced apart from the feed pattern 21 fed by the feed via 11, thereby being fed in a capacitive coupled feed manner.

Thus, a metal layer, i.e., the antenna patch 31, is not disposed between the second dielectric material block 120 and the feed pattern 21, and only the bonding layer 130 is disposed between the second dielectric material block 120 and the feed pattern 21.

The size and shape of the feed pattern 21 and the antenna patch 31 are changeable, and the design freedom of the antenna may be improved by modifying the size and shape of the feed pattern 21 and the antenna patch 31, and the spacing between the feed pattern 21 and the antenna patch 31.

The first dielectric material block 110 and the second dielectric material block 120 may include a ceramic material, and the bonding layer 130 may include a polymer. More specifically, the bonding layer 130 may include any one or any combination of any two or more of PI, PMMA, PTFE, PPE, BCB, and LCP-based polymers.

The specific dielectric constant of the first dielectric material block 110 and the specific dielectric constant of the second dielectric material block 120 may be the same as or different from each other. More specifically, the specific dielectric constant of the second dielectric material block 120 may be greater than the specific dielectric constant of the first dielectric material block 110.

The specific dielectric constant of the bonding layer 130 may be lower than the specific dielectric constant of the first dielectric material block 110 and the specific dielectric constant of the second dielectric material block 120.

The antenna 200 may have a rectangular parallelepiped shape having a first length a in the first direction DR1, a second length b in the second direction DR2, and a third length c in the third direction DR3.

When an electric signal is applied to the feed via 11, the resonance of a certain frequency occurs inside the first dielectric material block 110, the second dielectric material block 120, and the bonding layer 130, and the RF signals may be transmitted and received according to the resonance frequency of the antenna 200.

The resonance frequency inside the first dielectric material block 110, the second dielectric material block 120, and the bonding layer 130 may be determined from the specific dielectric constant value of the first dielectric material block 110, the second dielectric material block 120, and the bonding layer 130, the value of the first length a of the first direction DR1 of the antenna 200, the value of the second length b of the second direction DR2, the value of the third length c of the third direction DR3, and axis direction propagation constants parallel to each of the first direction DR1 to the third direction DR3.

When the resonance frequency of the antenna 200 is constant, the size of the antenna 200 is proportional to (e)^{-1/2} when the specific dielectric constant value of the first dielectric material block 110, the second dielectric material block 120, and the bonding layer 130 is referred to as “e”. Therefore, if the specific dielectric constant of the first dielectric material block 110, the second dielectric material block 120, and the bonding layer 130 is increased, the size of the antenna 200 may be reduced.

At this time, if the specific dielectric constant of the dielectric material blocks of the antenna 200 is increased, a conductor loss by the feed via 11, the feed pattern 21, and the antenna patch 31 may be increased.

However, according to the antenna 200 according to the present embodiment, the specific dielectric constant of the first dielectric material block 110 may be smaller than the specific dielectric constant of the second dielectric material block 120, and the feed via 11 may be disposed in the first dielectric material block 110 having the relatively small specific dielectric constant, and may not be disposed in the second dielectric material block 120 having the relatively large specific dielectric constant. Therefore, it is possible to prevent the efficiency deterioration of the antenna 200 by reducing the conductor loss due to the feed via 11, thereby increasing the gain of the antenna 200.

In addition, by forming the second thickness T2 of the second dielectric material block 120 having the relatively large specific dielectric constant to be larger than the first thickness T1 of the first dielectric material block 110 having the relatively small specific dielectric constant, it is possible to increase the entire specific dielectric constant of the first dielectric material block 110 and the second dielectric material block 120, thereby increasing the gain of the antenna 200 and reducing the size of the antenna 100.

Also, between the second dielectric material block 120 and the feed pattern 21, the antenna patch 31 is not disposed, and only the bonding layer 130 may be disposed. Accordingly, as shown in FIG. 8, the electric signal applied to the feed pattern 21 may be transmitted (CD) to the second dielectric material block 120, which has a relatively large specific dielectric constant value and a relatively thick thickness in the third direction DR3, without being blocked by a metal layer, i.e., the antenna patch 31. Therefore, the resonance frequency may occur in the second dielectric material block 120 disposed on the first dielectric material block 110, thereby increasing the efficiency of the antenna 200 even though the lengths a and b of the antenna 100 in the first direction DR1 and the second direction DR2 are not large. Therefore, it is possible to increase the gain and frequency band of the antenna 200.

In addition, by additionally transmitting and receiving the electric signal using the antenna patch 31 disposed between the first dielectric material block 110 and the second dielectric material block 120, the efficiency of the antenna 200 may be increased, and by disposing the antenna patch 31 adjacent to the bonding layer 130 with the relatively small specific dielectric constant, it is possible to reduce the conductor loss depending on the antenna patch 31, thereby increasing the gain of the antenna 200.

In addition, by including the antenna patch 31 that is disposed between the first dielectric material block 110 and the second dielectric material block 120 and is capacitively coupled with the feed pattern 21 to be fed with the power, the bandwidth of the antenna 200 may be expanded through the additional frequency resonance according to the antenna patch 31 without interfering with the electric signal applied to the second dielectric material block 120, and the gain of the antenna 200 may be increased.

In addition, as described above, the feed via 11 is disposed adjacent to the first position CP formed by the meeting of the first edge Ea parallel to the first direction DR1 and the second edge Eb parallel to the second direction DR2 on the bottom surface of the first dielectric material block 110, and with reference to the bottom surface of the first dielectric material block 110, the first center C1 of the feed via 11 may overlap the diagonal D1 of the bottom surface of the first dielectric material block 110 intersecting the first position CP.

As such, by disposing the feed via 11 so that the first center C1 of the feed via 11 overlaps the diagonal D1 of the bottom surface of the first dielectric material block 110 intersecting the first position CP, the distribution length of the electric field generated by the electric signal applied from the feed via 11 may be increased. Through this, the gain of the antenna 200 may be increased.

As such, according to the antenna 200 according to the embodiment, while the antenna 200 may be installed in a narrow region, the frequency band of the antenna 200 may be increased, and the gain of the antenna 200 may be increased.

Many features of the dielectric resonator antenna 100 according to the embodiment described with reference to FIG. 1 and FIG. 2 and the dielectric resonator antenna 101 according to the embodiment described with reference to FIG. 4 and FIG. 5 are applicable to the dielectric resonator antenna 200 according to the present embodiment.

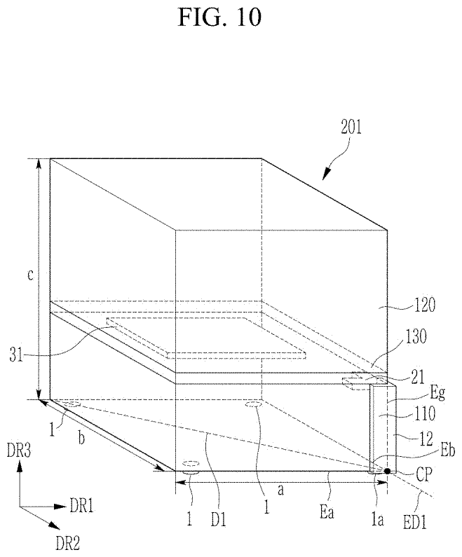

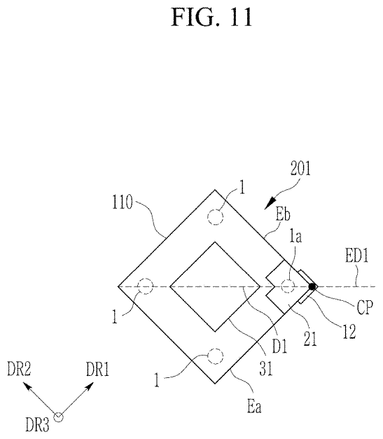

Next, an dielectric resonator antenna 201 according to another embodiment is described with reference to FIG. 10 and FIG. 11. FIG. 10 is a perspective view of a dielectric resonator antenna according to another embodiment, and FIG. 11 is a top plan view of the dielectric resonator antenna of FIG. 10.

Referring to FIG. 10 and FIG. 11, the antenna 201 according to the present embodiment is similar to the antenna 200 according to the embodiment described with reference to FIG. 6 to FIG. 8 above.

The antenna 201 according to the present embodiment includes the first dielectric material block 110 and the second dielectric material block 120 stacked in the third direction DR3, the bonding layer 130 disposed between the first dielectric material block 110 and the second dielectric material block 120 and bonding the first dielectric material block 110 and the second dielectric material block 120 to each other, the feed pattern 21 disposed between the first dielectric material block 110 and the second dielectric material block 120, and the antenna patch 31 disposed between the first dielectric material block 110 and the second dielectric material block 120 and separated from the feed pattern 21. Thus, a metal layer, i.e., the antenna patch 31, may not be disposed between the feed pattern 21 and the second dielectric material block 120. The detailed description of the same constituent elements as those of the antenna 200 according to the embodiment described with reference to FIG. 6 to FIG. 8 is omitted.

Unlike the antenna 200 according to the embodiment described with reference to FIG. 6 to FIG. 8, the antenna 201 according to present embodiment may include a feed strip 12 disposed on an outside surface of the first dielectric material block 110.

The feed strip 12 of the antenna 201 may be connected to the feed pattern 21 disposed on the first dielectric material block 110. The feed strip 12 may be the feeding unit of the antenna 201.

The feed strip 12 may be disposed on a first corner Eg of the first dielectric material block 110 extending in the third direction DR3 from the first position CP formed by the meeting of the first edge Ea parallel to the first direction DR1 and the second edge Eb parallel to the second direction DR2 on the bottom surface of the first dielectric material block 110. The feed strip 12 may touch the first position CP formed by the meeting of the first edge Ea parallel to the first direction DR1 and the second edge Eb parallel to the second direction DR2 on the bottom surface of the first dielectric material block 110.

With reference to the bottom surface of the first dielectric material block 110, the feed strip 12 may overlap the extension line ED1 of the diagonal D1 of the bottom surface of the first dielectric material block 110 intersecting the first position CP.

As such, by disposing the feed strip 12 to overlap the extension line ED1 of the diagonal D1 of the bottom surface of the first dielectric material block 110 intersecting the first position CP, the distribution length of the electric field generated by the electric signal applied from the feed strip 12 can be increased. Through this, the gain of the antenna 201 may be increased.

As the feed pattern 21 may be disposed to be spaced apart from the antenna patch 31 on a plane formed by the intersection of the first direction DR1 and the second direction DR2, and the feed pattern 21 and the antenna patch 31 are coupled to each other, the antenna patch 31 may be fed in a capacitive coupled feed manner through the feed pattern 21.

The electric signal applied to the feed strip 12 is transmitted to the first dielectric material block 110 and the second dielectric material block 120 to generate the resonance frequency, and is transmitted to the antenna patch 31 through the feed pattern 21 to additionally transmit and receive the electric signals, thereby increasing the efficiency of the dielectric resonator antenna 201.

Many features of the dielectric resonator antenna 100 according to the embodiment described with reference to FIG. 1 and FIG. 2, the dielectric resonator antenna 101 according to the embodiment described with reference to FIG. 4 and FIG. 5, and the dielectric resonator antenna 200 according to the embodiment described with reference to FIG. 6 to FIG. 8 are applicable to the dielectric resonator antenna 201 according to the present embodiment.

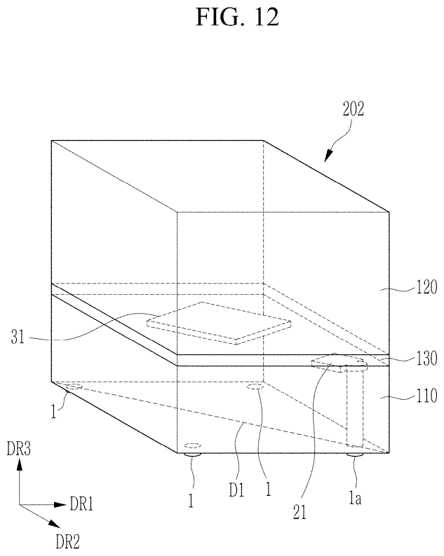

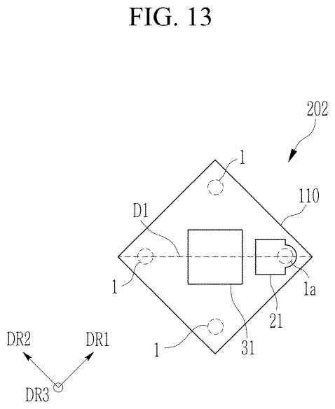

Next, an antenna 202 according to another embodiment is described with reference to FIG. 12 and FIG. 13. FIG. 12 is a perspective view of a dielectric resonator antenna according to another embodiment, and FIG. 13 is a top plan view of the dielectric resonator antenna of FIG. 12.

Referring to FIG. 12 and FIG. 13, the antenna 202 according to the present embodiment is similar to the antenna 200 according to the embodiment described with reference to FIG. 6 to FIG. 8 above.

The antenna 202 according to the present embodiment includes the first dielectric material block 110 and the second dielectric material block 120 stacked in the third direction DR3, the bonding layer 130 disposed between the first dielectric material block 110 and the second dielectric material block 120 to bond the first dielectric material block 110 and the second dielectric material block 120, the feed pattern 21 disposed between the first dielectric material block 110 and the second dielectric material block 120, and the antenna patch 31 disposed between the first dielectric material block 110 and the second dielectric material block 120 and separated from the feed pattern 21. Thus, a metal layer, i.e., the antenna patch 31, may not be disposed between the feed pattern 21 and the second dielectric material block 120. The detailed description of the same constituent elements as those of the antenna 200 according to the embodiment described with reference to FIG. 6 to FIG. 8 is omitted.

Unlike the antenna 200 according to the embodiment described with reference to FIG. 6 to FIG. 8, two edges of the antenna patch 31 of the antenna 202 according to the present embodiment may be parallel to the diagonal D1 of the bottom surface of the first dielectric material block 110 intersecting the first position CP. Therefore, the main direction of the electric field distribution occurring on the upper surface of the second dielectric material block 120 parallel to the diagonal D1 and the direction of two edges of the antenna patch 31 are parallel to each other, and then the electric field distribution direction according to the surface current flowing along the two edges of the antenna patch 31 and the electric field direction of the second dielectric material block 120 are parallel to each other, and thereby the gain of the antenna 202 may be larger.

Also, similar to the antenna 200 according to the embodiment described with reference to FIG. 6 to FIG. 8, by disposing the feed via 11 to overlap the diagonal D1 of the bottom surface of the first dielectric material block 110 intersecting the first position CP, the distribution length of the electric field generated by the electric signal applied from the feed via 11 may be increased. Through this, the gain of the antenna 202 may be increased.

As the feed pattern 21 may be disposed to be spaced apart from the antenna patch 31 on a plane formed by the intersection of the first direction DR1 and the second direction DR2, and the feed pattern 21 and the antenna patch 31 are coupled to each other, the antenna patch 31 may be fed in a capacitive coupled feed manner through the feed pattern 21.

The electric signal applied to the feed via 11 is transmitted to the first dielectric material block 110 and the second dielectric material block 120 to generate the resonance frequency, and is transmitted to the antenna patch 31 through the feed pattern 21 to additionally transmit and receive the electric signals, thereby increasing the efficiency of the dielectric resonator antenna 202.

Many features of the dielectric resonator antenna 100 according to the embodiment described with reference to FIG. 1 and FIG. 2, the dielectric resonator antenna 101 according to the embodiment described with reference to FIG. 4 and FIG. 5, the dielectric resonator antenna 200 according to the embodiment described with reference to FIG. 6 to FIG. 8, and the dielectric resonator antenna 201 according to the embodiment described with reference to FIG. 10 and FIG. 11 are applicable to the dielectric resonator antenna 202 according to the present embodiment.

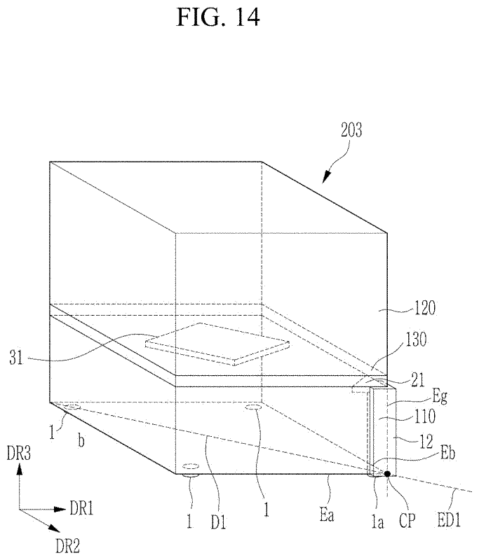

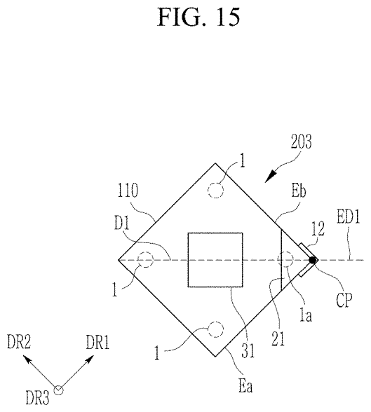

Next, an antenna 203 according to another embodiment is described with reference to FIG. 14 and FIG. 15. FIG. 14 is a perspective view of a dielectric resonator antenna according to another embodiment, and FIG. 15 is a top plan view of the dielectric resonator antenna of FIG. 14.

Referring to FIG. 14 and FIG. 15, the antenna 203 according to the present embodiment is similar to the antenna 200 according to the embodiment described with reference to FIG. 6 to FIG. 8 above.

The antenna 203 according to the present embodiment includes the first dielectric material block 110 and the second dielectric material block 120 stacked in the third direction DR3, the bonding layer 130 disposed between the first dielectric material block 110 and the second dielectric material block 120 to bond the first dielectric material block 110 and the second dielectric material block 120, the feed pattern 21 disposed between the first dielectric material block 110 and the second dielectric material block 120, and the antenna patch 31 disposed between the first dielectric material block 110 and the second dielectric material block 120 and separated from the feed pattern 21. Thus, a metal layer, i.e., the antenna patch 31, may not be disposed between the feed pattern 21 and the second dielectric material block 120. The detailed description of the same constituent elements as those of the antenna 200 according to the embodiment described with reference to FIG. 6 to FIG. 8 is omitted.

Unlike the antenna 200 according to the embodiment described with reference to FIG. 6 to FIG. 8, two edges of the antenna patch 31 of the antenna 203 according to the present embodiment may be parallel to the diagonal D1 of the bottom surface of the first dielectric material block 110 intersecting the first position CP. Therefore, the main direction of the electric field distribution occurring on the upper surface of the second dielectric material block 120 parallel to the diagonal D1 and the direction of the two edges of the antenna patch 31 are parallel to each other, and then the electric field distribution direction according to the surface current flowing along the two edges of the antenna patch 31 and the electric field direction of the second dielectric material block 120 are parallel to each other, and thereby the gain of the antenna 203 may be larger.

Also, unlike the antenna 200 according to the embodiment described with reference to FIG. 6 to FIG. 8, the antenna 203 according to the present embodiment may include the feed strip 12 disposed on the outside surface of the first dielectric material block 110.

The feed strip 12 of the antenna 203 may be connected to the feed pattern 21 disposed on the first dielectric material block 110. The feed strip 12 may be a feeding unit of the antenna 203.

The feed strip 12 may be disposed on the first corner Eg of the first dielectric material block 110 extending in the third direction DR3 from the first position CP formed by the meeting of the first edge Ea parallel to the first direction DR1 and the second edge Eb parallel to the second direction DR2 on the bottom surface of the first dielectric material block 110. The feed strip 12 may touch the first position CP formed by the meeting of the first edge Ea parallel to the first direction DR1 and the second edge Eb parallel to the second direction DR2 on the bottom surface of the first dielectric material block 110.

With reference to the bottom surface of the first dielectric material block 110, the feed strip 12 may overlap the extension line ED1 of the diagonal D1 of the bottom surface of the first dielectric material block 110 intersecting the first position CP.

As such, by disposing the feed strip 12 to overlap the extension line ED1 of the diagonal D1 of the bottom surface of the first dielectric material block 110 intersecting the first position CP, the distribution length of the electric field generated by the electric signal applied from the feed strip 12 can be increased. Through this, the gain of the antenna 203 may be increased.

As the feed pattern 21 may be disposed to be spaced apart from the antenna patch 31 on a plane formed by the intersection of the first direction DR1 and the second direction DR2, and the feed pattern 21 and the antenna patch 31 are coupled to each other, the antenna patch 31 may be fed in a capacitive coupled feed manner through the feed pattern 21.

The electric signal applied to the feed strip 12 is transmitted to the first dielectric material block 110 and the second dielectric material block 120 to generate the resonance frequency, and is transmitted to the antenna patch 31 through the feed pattern 21 to additionally transmit and receive the electric signals, thereby increasing the efficiency of the dielectric resonator antenna 201.

Many features of the dielectric resonator antenna 100 according to the embodiment described with reference to FIG. 1 and FIG. 2, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, and the dielectric resonator antenna 202 according to the embodiment described with reference to FIG. 12 and FIG. 13 are applicable to the dielectric resonator antenna 203 according to the present embodiment.

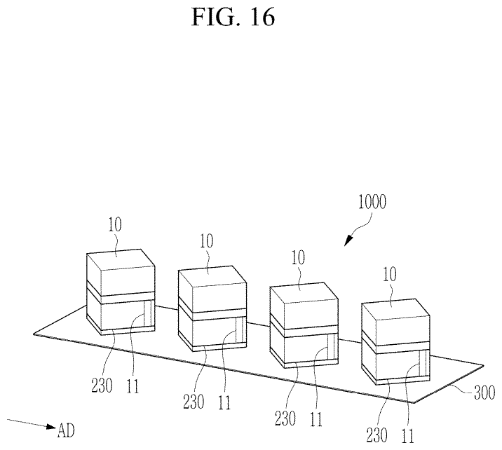

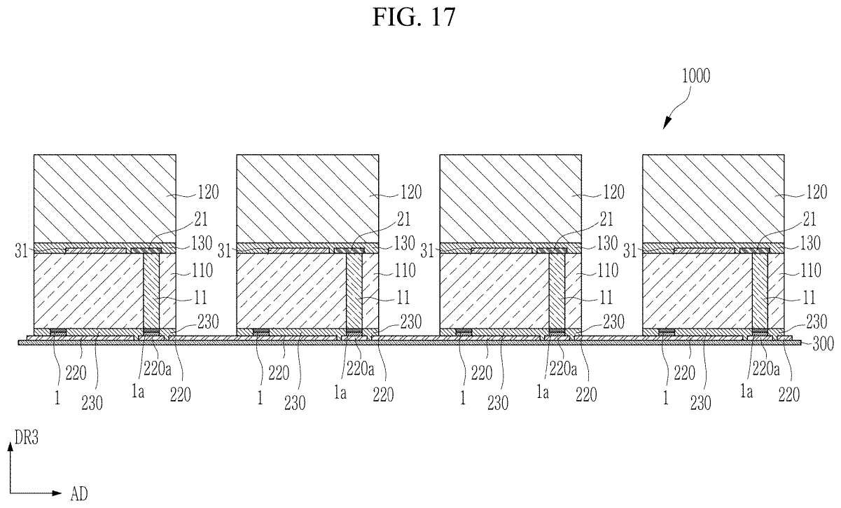

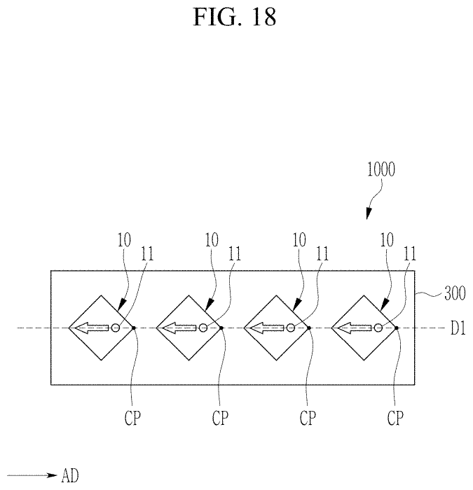

Next, an antenna module 1000 including a plurality of dielectric resonator antennas 10 according to an embodiment is described with reference to FIG. 16 to FIG. 18. FIG. 16 is a perspective view of an antenna module including a plurality of dielectric resonator antennas according to an embodiment, FIG. 17 is a schematic cross-sectional view of the antenna module of FIG. 16, and FIG. 18 is a schematic top plan view of the antenna module of FIG. 16.

Referring to FIG. 16 to FIG. 18, the antenna module 1000 according to the present embodiment may include the plurality of dielectric resonator antennas 10 disposed along a line extending in a fourth direction AD on a connection substrate 300. The plurality of dielectric resonator antennas 10 may be arranged in the fourth direction AD that is an arranging direction.

The connection substrate 300 may include a signal wire capable of applying an electric signal to the plurality of antennas 10 such as a ground electrode and a feeding wire.

The plurality of dielectric resonator antennas 10 may be connected to the connection substrate 300 through a plurality of connection parts 1 and 1a described above.

Referring to FIG. 16 and FIG. 17, an underfill material 230 can be disposed between the connection substrate 300 and the antennas 10.

When mounting the antennas 10 to the connection substrate 300, after connecting the feed via 11 to the feeding wire 220a of the connection substrate 300 through the part 1a of the plurality of connection parts 1 and 1a, and to the ground electrode 220 of the connection substrate 300 through the other parts 1 of the plurality of connection parts 1 and 1a, the underfill material 230 may be filled and cured in the space between the plurality of antennas 10 and the connection substrate 300. The cured underfill material 230 may be formed to surround a portion in which the plurality of connection parts 1 and 1a and antennas 10 are connected to each other, thereby supporting the antennas 10 to be firmly fixed on the connection substrate 300. In addition, the underfill material 230 fills the space between the plurality of antennas 10 and the connection substrate 300 to prevent dust or moisture from penetrating from the outside, thereby preventing damage to the connection parts 1 and 1a and the connection substrate 200 and a resulting malfunction.

The plurality of dielectric resonator antennas 10 may include the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15. However, the present disclosure is not limited thereto, and the plurality of dielectric resonator antennas 10 may include the dielectric resonator antenna 100 according to the embodiment described with reference to FIG. 1 and FIG. 2 and the dielectric resonator antenna 101 according to the embodiment described with reference to FIG. 4 and FIG. 5.

Referring to FIG. 16 to FIG. 18, the feed vias 11 of the plurality of dielectric resonator antennas 10 are disposed adjacent to the first position CP of the bottom surfaces of the plurality of dielectric resonator antennas 10.

With reference to the bottom surface of the plurality of dielectric resonator antennas 10, the feed via 11 may overlap the diagonal D1 of the bottom surface of the plurality of dielectric resonator antennas 10 intersecting the first position CP. In addition, the feed via 11 may be disposed closer to the first position CP than the center portion of the bottom surface of the plurality of dielectric resonator antennas 10.

The direction of the diagonal D1 of the bottom surface of the plurality of dielectric resonator antennas 10 may be parallel to the fourth direction AD. In addition, the distribution direction of the electric field on the upper surface of the plurality of dielectric resonator antennas 10 is shown by an arrow in FIG. 18, and as the direction of the surface current of the upper surface of the plurality of dielectric resonator antennas 10 are disposed parallel to each other, it is possible to increase the gain according to the antenna arrangement.

As described above, by disposing the feed via 11 of the plurality of dielectric resonator antennas 10 to overlap the diagonal D1 of the bottom surface of the plurality of dielectric resonator antennas 10 intersecting the first position CP, the distribution length of the electric field generated by the electric signal applied from the feed via 11 may be increased. Through this, the gain of the antenna module 1000 may be increased.

Many features of the dielectric resonator antenna 100 according to the embodiment described with reference to FIG. 1 and FIG. 2, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15 are applicable to the antenna module 1000 according to the present embodiment.

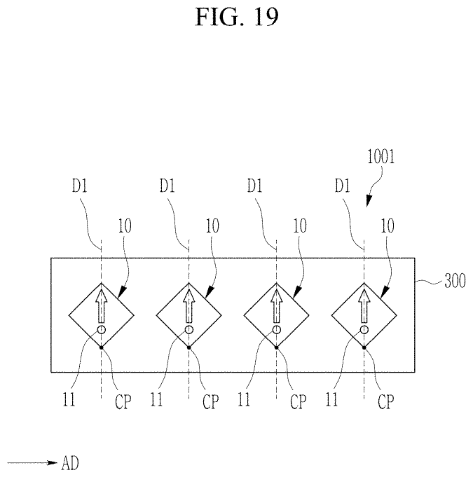

Next, an antenna module 1001 according to another embodiment is described with reference to FIG. 19. FIG. 19 is a top plan view of an antenna module according to another embodiment.

Referring to FIG. 19, the antenna module 1001 according to the present embodiment may include a plurality of dielectric resonator antennas 10 disposed along a line extending in a fourth direction AD on a connection substrate 300. The plurality of dielectric resonator antennas 10 may be arranged in the fourth direction AD that is an arranging direction.

The feed vias 11 of the plurality of dielectric resonator antennas 10 are disposed adjacent to the first position CP of the bottom surfaces of the plurality of dielectric resonator antennas 10.

With reference to the bottom surface of the plurality of dielectric resonator antennas 10, the feed via 11 may overlap an extension of the diagonal D1 of the bottom surface of the plurality of dielectric resonator antennas 10 intersecting the first position CP. In addition, the feed via 11 may be disposed closer to the first position CP than the center portion of the bottom surface of the plurality of dielectric resonator antennas 10.

However, unlike the antenna module 1000 according to the embodiment described with reference to FIG. 16 to FIG. 18, the direction of the diagonal D1 of the bottom surface of the plurality of dielectric resonator antennas 10 of the antenna module 1001 according to the present embodiment is not parallel to the fourth direction AD, and may form an almost right angle thereto.

The distribution direction of the electric field on the upper surface of the plurality of dielectric resonator antennas 10 is shown by the arrow in FIG. 19, and the distribution direction of the electric field on the upper surface of the plurality of dielectric resonator antennas 10 may be the same. By disposing the distribution directions of the electric field on the upper surface of the plurality of dielectric resonator antennas 10 to be the same, the gain according to the antenna arrangement may be increased.

As described above, by disposing the feed via 11 of the plurality of dielectric resonator antennas 10 to overlap the diagonal D1 of the bottom surface of the plurality of dielectric resonator antennas 10 intersecting the first position CP, the distribution length of the electric field generated by the electric signal applied from the feed via 11 may be increased. Through this, the gain of the antenna module 1001 may be increased.

The plurality of dielectric resonator antennas 10 of the antenna module 1001 according to the present embodiment may include the dielectric resonator antenna 100 according to the embodiment described with reference to FIG. 1 and FIG. 2 above, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15.

Many features of the dielectric resonator antenna 100 according to the embodiment described with reference to FIG. 1 and FIG. 2, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15 are applicable to the antenna module 1001 according to the present embodiment.

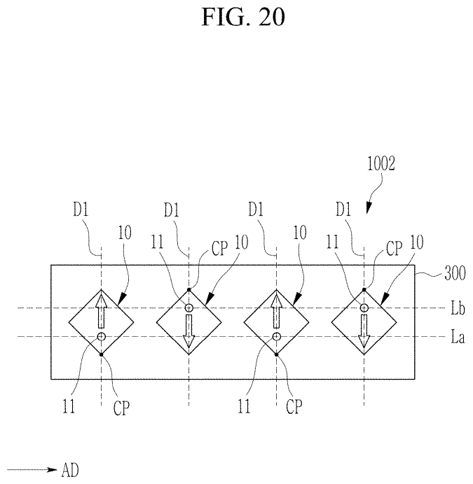

Next, an antenna module 1002 according to another embodiment is described with reference to FIG. 20. FIG. 20 is a top plan view of an antenna module according to another embodiment.

Referring to FIG. 20, the antenna module 1002 according to the present embodiment may include a plurality of dielectric resonator antennas 10 disposed along a line extending in a fourth direction AD on a connection substrate 300. The plurality of dielectric resonator antennas 10 may be arranged in the fourth direction AD that is an arranging direction.

The feed vias 11 of the plurality of dielectric resonator antennas 10 are disposed adjacent to the first position CP of the bottom surfaces of the plurality of dielectric resonator antennas 10.

With reference to the bottom surface of the plurality of dielectric resonator antennas 10, the feed via 11 may overlap the diagonal D1 of the bottom surface of the plurality of dielectric resonator antennas 10 intersecting the first position CP. In addition, the feed via 11 may be disposed closer to the first position CP than the center portion of the bottom surface of the plurality of dielectric resonator antennas 10.

The direction of the diagonal D1 of the bottom surface of the plurality of dielectric resonator antennas 10 of the antenna module 1002 according to the present embodiment is not parallel to the fourth direction AD, and may form an almost right angle thereto.

According to the antenna module 1002 according to the present embodiment, a virtual first line La connecting the feed vias 11 of the dielectric resonator antennas 10 in the odd-numbered positions counting from the left among the plurality of dielectric resonator antennas 10 and extending in a direction parallel to the fourth direction AD and a virtual second line Lb connecting the feed vias 11 of the dielectric resonator antennas 10 in the even-numbered position counting from the left among the plurality of dielectric resonator antennas 10 and extending in a direction parallel to the fourth direction AD are parallel to each other, but not coincident with each other, so that the feed vias 11 of the plurality of dielectric resonator antennas 10 may not be disposed along a single line extending in the fourth direction AD.

The distribution direction of the electric field on the upper surface of the plurality of dielectric resonator antennas 10 is shown by the arrow in FIG. 20, and the distribution directions of the electric field on the upper surface of a plurality of dielectric resonator antennas 10 are parallel to each other, but may be opposite to each other. By disposing the distribution direction of the electric field of the upper surface of the plurality of dielectric resonator antennas 10 to be parallel to each other, the signals of the plurality of dielectric resonator antennas 10 may not interfere with each other, and by disposing the distribution directions of the electric field on the upper surface of the plurality of dielectric resonator antennas 10 in the opposite directions, the propagation direction of the signals of the plurality of dielectric resonator antennas 10 may be varied.

As described above, by disposing the feed via 11 of the plurality of dielectric resonator antennas 10 to overlap the diagonal D1 of the bottom surface of the plurality of dielectric resonator antennas 10 intersecting the first position CP, the distribution length of the electric field generated by the electric signal applied from the feed via 11 may be increased. Through this, the gain of the antenna module 1002 may be increased.

The plurality of dielectric resonator antennas 10 of the antenna module 1002 according to the present embodiment may include the dielectric resonator antenna 100 according to the embodiment described with reference to FIG. 1 and FIG. 2 above, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15.

Many features of the dielectric resonator antenna 100 according to the embodiment described with reference to FIG. 1 and FIG. 2, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15 are applicable to the antenna module 1002 according to the present embodiment.

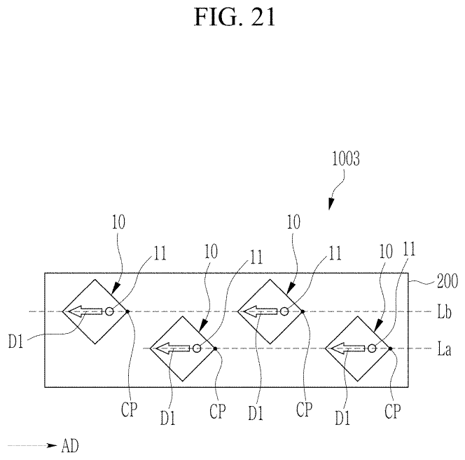

Next, an antenna module 1003 according to another embodiment is described with reference to FIG. 21. FIG. 21 is a top plan view of an antenna module according to another embodiment.

Referring to FIG. 21, the antenna module 1003 according to the present embodiment may include a plurality of dielectric resonator antennas 10 disposed along two lines extending in directions parallel to a fourth direction AD on a connection substrate 300. The plurality of dielectric resonator antennas 10 may be arranged in directions parallel to the fourth direction AD that is an arranging direction.

The plurality of dielectric resonator antennas 10 may not be disposed along a single line extending in the fourth direction AD, but may be sequentially disposed in a zigzag arrangement along two lines extending in directions parallel to the fourth direction AD.

Accordingly, a virtual first line La connecting the feed vias 11 of the dielectric resonator antennas 10 in the even-numbered positions counting from the left among the plurality of dielectric resonator antennas 10 and extending in a direction parallel to the fourth direction AD and a virtual second line Lb connecting the feed vias 11 of the dielectric resonator antennas 10 in the odd-numbered positions counting from the left among the plurality of dielectric resonator antennas 10 and extending in a direction parallel to the fourth direction AD are parallel to each other, but not coincident with each other, and the feed vias 11 of the plurality of dielectric resonator antennas 10 may not be disposed along a single line extending in the fourth direction AD.

As such, by not disposing the plurality of dielectric resonator antennas 10 in a single row, the interference between adjacent dielectric resonator antennas 10 may be reduced.

The distribution direction of the electric field on the upper surface of the plurality of dielectric resonator antennas 10 is shown by the arrow in FIG. 21, and by disposing the distribution direction of the electric field on the top surface of the plurality of dielectric resonator antennas 10 to be parallel to each other, it is possible to increase the gain according to the antenna arrangement.

The feed vias 11 of the plurality of dielectric resonator antennas 10 are disposed adjacent to the first position CP of the bottom surfaces of the plurality of dielectric resonator antennas 10.

With reference to the bottom surface of the plurality of dielectric resonator antennas 10, the feed via 11 may overlap the diagonal D1 of the bottom surface of the plurality of dielectric resonator antennas 10 intersecting the first position CP. In addition, the feed via 11 may be disposed closer to the first position CP than the center portion of the bottom surface of the plurality of dielectric resonator antennas 10.

As described above, by disposing the feed via 11 of the plurality of dielectric resonator antennas 10 to overlap the diagonal D1 of the bottom surface of the plurality of dielectric resonator antennas 10 intersecting the first position CP, the distribution length of the electric field generated by the electric signal applied from the feed via 11 may be increased. Through this, the gain of the antenna module 1003 may be increased.

The plurality of dielectric resonator antennas 10 may include the dielectric resonator antenna 100 according to the embodiment described with reference to FIG. 1 and FIG. 2 above, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15.

Many features of the dielectric resonator antenna 100 according to the embodiment described with reference to FIG. 1 and FIG. 2, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15 are applicable to the antenna module 1003 according to the present embodiment.

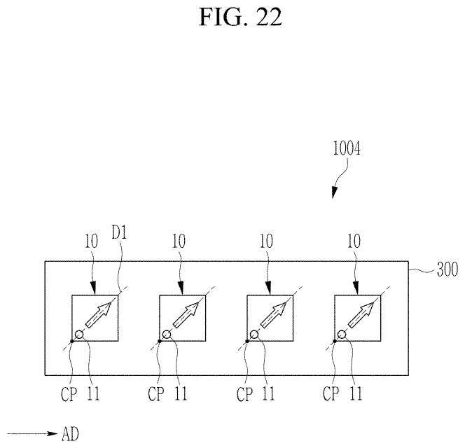

Next, an antenna module 1004 according to another embodiment is described with reference to FIG. 22. FIG. 22 is a top plan view of an antenna module according to another embodiment.

Referring to FIG. 22, the antenna module 1004 according to the present embodiment may include a plurality of dielectric resonator antennas 10 disposed along a line extending in a fourth direction AD on a connection substrate 300. The plurality of dielectric resonator antennas 10 may be arranged in the fourth direction AD that is an arranging direction.

The feed vias 11 of the plurality of dielectric resonator antennas 10 are disposed adjacent to the first position CP of the bottom surfaces of the plurality of dielectric resonator antennas 10.

With reference to the bottom surface of the plurality of dielectric resonator antennas 10, the feed via 11 may overlap the diagonal D1 of the bottom surface of the plurality of dielectric resonator antennas 10 intersecting the first position CP. In addition, the feed via 11 may be disposed closer to the first position CP than the center portion of the bottom surface of the plurality of dielectric resonator antennas 10.

With reference to the bottom surface of the plurality of dielectric resonator antennas 10, the diagonal D1 of the bottom surface of the plurality of dielectric resonator antennas 10 intersecting the first position CP may form a predetermined angle of less than about 90 degrees with the fourth direction AD, for example, about 45 degrees may be formed.

The diagonals D1 of the bottom surfaces of the plurality of dielectric resonator antennas 10 may be parallel to each other.

The distribution direction of the electric field on the upper surface of the plurality of dielectric resonator antennas 10 is shown by an arrow in FIG. 22, and by disposing the distribution direction of the electric field on the top surface of the plurality of dielectric resonator antennas 10 to be parallel to each other, it is possible to increase the gain according to the antenna arrangement.

As described above, by disposing the feed via 11 of the plurality of dielectric resonator antennas 10 to overlap the diagonal D1 of the bottom surface of the plurality of dielectric resonator antennas 10 intersecting the first position CP, the distribution length of the electric field generated by the electric signal applied from the feed via 11 may be increased. Through this, the gain of the antenna module 1004 may be increased.

The plurality of dielectric resonator antennas 10 may include the dielectric resonator antenna 100 according to the embodiment described with reference to FIG. 1 and FIG. 2 above, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15.

Many features of the dielectric resonator antenna 100 according to the embodiment described with reference to FIG. 1 and FIG. 2, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15 are applicable to the antenna module 1004 according to the present embodiment.

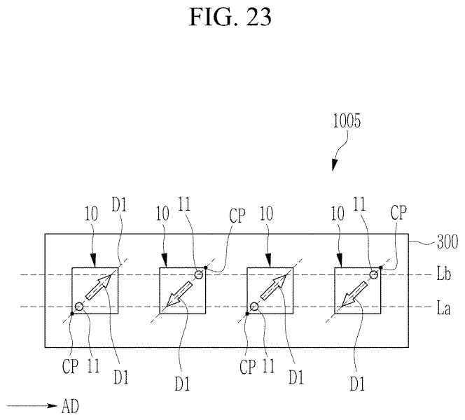

Next, an antenna module 1005 according to another embodiment is described with reference to FIG. 23. FIG. 23 is a top plan view of an antenna module according to another embodiment.

Referring to FIG. 23, the antenna module 1005 according to the present embodiment may include a plurality of dielectric resonator antennas 10 disposed along a line extending in a fourth direction AD on a connection substrate 300. The plurality of dielectric resonator antennas 10 may be arranged in the fourth direction AD that is an arranging direction.

A virtual first line La connecting the feed vias 11 of the dielectric resonator antennas 10 in the odd-numbered positions counting from the left among the plurality of dielectric resonator antennas 10 and extending in a direction parallel to the fourth direction AD and a virtual second line Lb connecting the feed vias 11 of the dielectric resonator antennas 10 in the even-numbered positions counting from the left among the plurality of dielectric resonator antennas 10 and extending in a direction parallel to the fourth direction AD are parallel to each other, but not coincident with each other, and the feed vias 11 of the plurality of dielectric resonator antennas 10 may not be disposed along a single line extending in the fourth direction AD.

The feed vias 11 of a plurality of dielectric resonator antennas 10 are disposed adjacent to the first position CP of the bottom surfaces of a plurality of dielectric resonator antennas 10.

With reference to the bottom surface of the plurality of dielectric resonator antennas 10, the feed via 11 may overlap the diagonal D1 of the bottom surface of the plurality of dielectric resonator antennas 10 intersecting the first position CP. In addition, the feed via 11 may be disposed closer to the first position CP than the center portion of the bottom surface of the plurality of dielectric resonator antennas 10.

With reference to the bottom surface of the plurality of dielectric resonator antennas 10, the diagonal D1 of the bottom surface of the plurality of dielectric resonator antennas 10 intersecting the first position CP may form a predetermined angle of less than about 90 degrees with the fourth direction AD, for example, about 45 degrees may be formed.

The diagonal D1 of the bottom surfaces of the plurality of dielectric resonator antennas 10 may be parallel to each other.

The distribution direction of the electric field on the upper surface of the plurality of dielectric resonator antennas 10 is shown by the arrow in FIG. 23, and the distribution directions of the electric field on the upper surface of the plurality of dielectric resonator antennas 10 are parallel to each other, but may be opposite to each other. By disposing the distribution direction of the electric field of the upper surface of the plurality of dielectric resonator antennas 10 to be parallel to each other, the signals of the plurality of dielectric resonator antennas 10 may not interfere with each other, and by disposing the distribution directions of the electric field on the upper surface of the plurality of dielectric resonator antennas 10 in the opposite directions, the propagation direction of the signals of the plurality of dielectric resonator antennas 10 may be varied.

As described above, by disposing the feed via 11 of the plurality of dielectric resonator antennas 10 to overlap the diagonal D1 of the bottom surface of the plurality of dielectric resonator antennas 10 intersecting the first position CP, the distribution length of the electric field generated by the electric signal applied from the feed via 11 may be increased. Through this, the gain of the antenna module 1005 may be increased.

The plurality of dielectric resonator antennas 10 may include the dielectric resonator antenna 100 according to the embodiment described with reference to FIG. 1 and FIG. 2 above, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15.

Many features of the dielectric resonator antenna 100 according to the embodiment described with reference to FIG. 1 and FIG. 2, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15 are applicable to the antenna module 1005 according to the present embodiment.

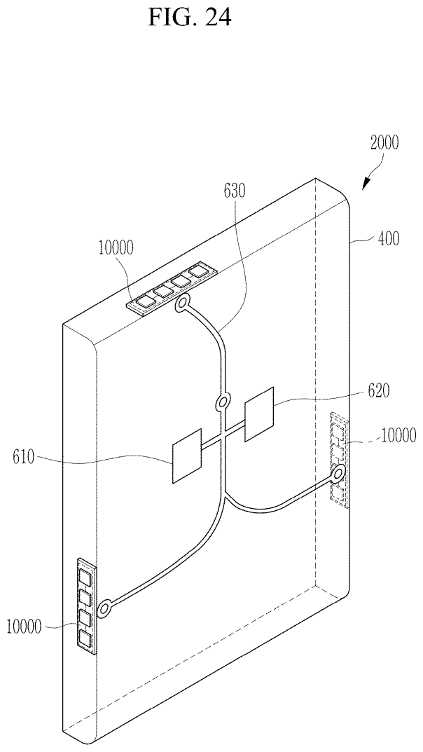

Now, an electronic device 2000 including the dielectric resonator antenna device according to an embodiment is described with reference to FIG. 24. FIG. 24 is a view showing an electronic device including a dielectric resonator antenna module according to an embodiment.

Referring to FIG. 24, an electronic device 2000 according to the embodiment includes a plurality of dielectric resonator antenna modules 10000 disposed in an assembly 400 of the electronic device 2000.

The electronic device 2000 may be a smart phone, a personal digital assistant, a digital video camera, a digital still camera, a network system, a computer, a monitor, a tablet, a laptop, a netbook, a television, a video game, a smart watch, or an automotive part, but it is not limited thereto.

The electronic device 2000 may have polygonal sides, and the dielectric resonator antenna modules 10000 may be disposed adjacent to at least some of the sides of the electronic device 2000.

A communication module 610 and a baseband circuit 620 may be disposed in the assembly 400. The dielectric resonator antenna modules 10000 may be electrically connected to the communication module 610 and the baseband circuit 620 through a coaxial cable 630.

The communication module 610 may include at least one among a memory chip such as a volatile memory (e.g., a DRAM), a non-volatile memory (e.g., a ROM), a flash memory to perform digital signal processing, an application processor chip such as a central processor (e.g., a CPU), a graphics processor (e.g., a GPU), a digital signal processor, an encryption processor, a microprocessor, a microcontroller, a logic chip such as an analog-digital converter, and an application-specific integrated circuit (ASIC).

The baseband circuit 620 may generate a baseband signal by performing analog-digital conversion, amplification of an analog signal, filtering, and frequency conversion. The baseband signal output from the baseband circuit 620 may be transmitted to an integrated circuit (IC) through an electrical connection structure, core vias, and wiring. The IC may convert the baseband signal into an RF signal of a millimeter waveband.

The dielectric resonator antenna modules 10000 may include any one or any combination of any two or more of the dielectric resonator antenna modules 1000, 1001, 1002, 1003, 1004, and 1005 previously described with reference to FIG. 16 to FIG. 23.

Many features of the dielectric resonator antenna module 1000, 1001, 1002, 1003, 1004, and 1005 described previously with reference to FIG. 16 to FIG. 23 are applicable to the electronic device 2000 according to the present embodiment.

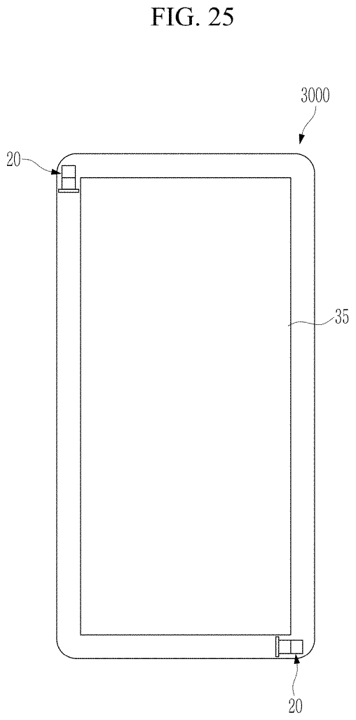

Next, an electronic device 3000 including the dielectric resonator antenna according to an embodiment is described with reference to FIG. 25. FIG. 25 is a view showing an electronic device including a dielectric resonator antenna according to another embodiment.

Referring to FIG. 25, the electronic device 3000 according to the embodiment may include a plurality of dielectric resonator antennas 20 disposed by an assembly substrate 35 of the electronic device 3000. The electronic device 3000 may have polygonal sides, and the dielectric resonator antennas 20 may be disposed adjacent to and parallel with at least some of the sides of the electronic device 3000.

For example, one or more of the dielectric resonator antennas 20 may be disposed adjacent to one or more of the front and rear sides of the electronic device 3000 so that a vertical direction of the one or more of the dielectric resonator antennas 20 may be disposed parallel with the one or more of the front and rear sides of the electronic device 3000. Also, one or more of the dielectric resonator antennas 20 may be disposed adjacent to one or more of the left, right, top, and bottom sides of the electronic device 3000 so that a vertical direction of the one or more of the dielectric resonator antennas 20 may be disposed parallel with the one or more of the left, right, top, and bottom sides of the electronic device 3000.

The dielectric resonator antennas 20 according to the embodiment may include any one or any combination of any two or more of the antennas 100, 101, 200, 201, 202, and 203 according to the embodiments described above.

The dielectric resonator antenna 20 may have an almost rectangular parallelepiped shape so it is easy to be disposed along the edge adjacent to the edge of the electronic device 3000.

Many features of the dielectric resonator antenna 100 according to the embodiment described with reference to FIG. 1 and FIG. 2, the dielectric resonator antenna 101 according to the embodiment described with reference to FIG. 4 and FIG. 5, the dielectric resonator antenna 200 according to the embodiment described with reference to FIG. 6 to FIG. 8, the dielectric resonator antenna 201 according to the embodiment described with reference to FIG. 10 and FIG. 11, the dielectric resonator antenna 202 according to the embodiment described with reference to FIG. 12 and FIG. 13, and the dielectric resonator antenna 203 according to the embodiment described with reference to FIG. 14 and FIG. 15 are applicable to the electronic device 3000 according to the present embodiment.

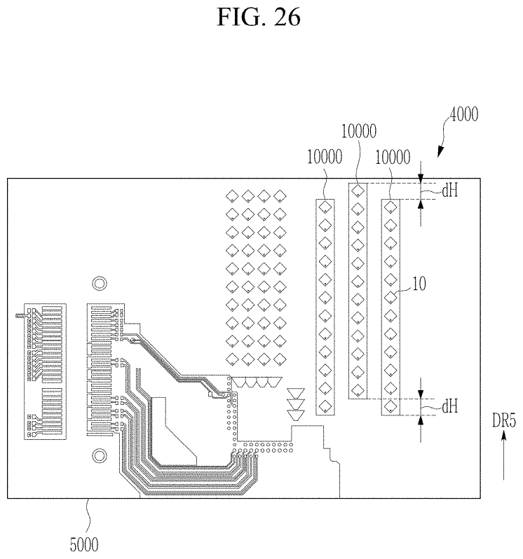

Next, an electronic device 4000 including the dielectric resonator antenna device according to an embodiment is described with reference to FIG. 26. FIG. 26 is a view showing an electronic device including a dielectric resonator antenna module according to another embodiment.

Referring to FIG. 26, the electronic device 4000 according to the embodiment includes a plurality of dielectric resonator antenna modules 10000 disposed on a circuit board 5000 of the electronic device 2000. The circuit board 5000 may be installed in a vehicle, and the circuit board 5000 may be installed perpendicular to the bottom surface of the vehicle, that is, in a fifth direction DR5 that is perpendicular to a ground.

The dielectric resonator antenna module 10000 may include a plurality of dielectric resonator antennas 10 arranged along lines extending in directions parallel to the fifth direction DR5.

Two dielectric resonator antenna modules 10000 adjacent to each other among the plurality of dielectric resonator antenna modules 10000 in a direction perpendicular to the fifth direction DR5 may be disposed to be displaced from each other by a spacing distance dH in the fifth direction DR5.

In this way, by disposing the plurality of dielectric resonator antenna modules 10000 to be displaced from each other by the spacing distance dH in the fifth direction DR5 so that there are difference distances between the ground and the plurality of dielectric resonator antenna modules 10000, the performance of an antenna constitute by the dielectric resonator antenna modules 10000 installed in the vehicle may be improved.

The dielectric resonator antenna modules 10000 may include any one or any combination of any two or more of the dielectric resonator antenna modules 1000, 1001, 1002, 1003, 1004, and 1005 described with reference to FIG. 16 to FIG. 23 above.

Many features of the dielectric resonator antenna modules 1000, 1001, 1002, 1003, 1004, and 1005 described with reference to FIG. 16 to FIG. 23 above are applicable to the electronic device 4000 according to the present embodiment.

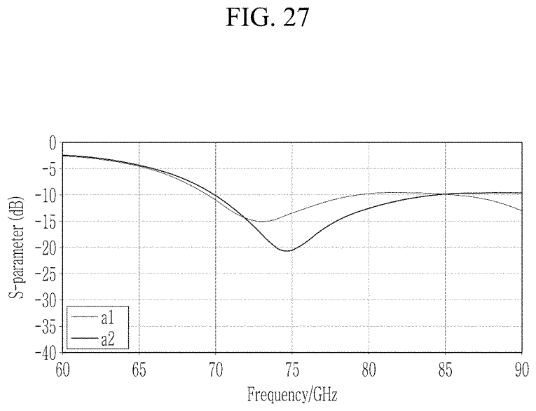

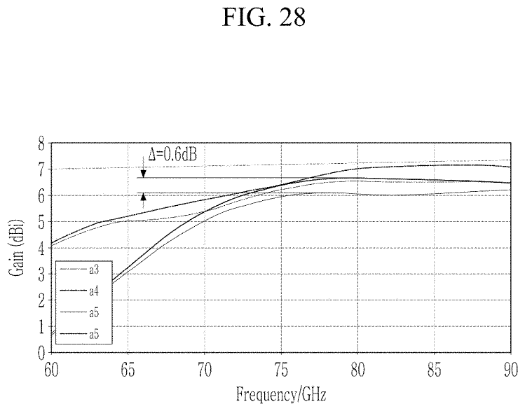

Now, an experimental example is described with reference to FIG. 27 and FIG. 28. FIG. 27 and FIG. 28 are graphs showing results of an experimental example.

In the experimental example, a dielectric resonator antenna with a volume of 0.95 mm×0.95 mm×0.96 mm was formed, and an S-parameter was measured and a gain of the antenna was measured for a first case in which a feed via was formed adjacent to the center of the edge of the dielectric material block like in the antenna 100a according to the conventional art of FIG. 3, and a second case in which a feed via was formed adjacent to a first position and the center of the feed via is disposed to overlap the diagonal of the bottom surface of the dielectric material block passing the first position like in the antennas according to the embodiments described herein.

The results of the S-parameters in the first case and the second case are shown in FIG. 27, and the results of the antenna gains in the first case and the second case are shown in FIG. 28. In particular, in FIGS. 27, a1 and a2 show averages of S-parameters.

In FIG. 27, a1 denotes the result in the first case, and a2 denotes the result in the second case.

Referring to FIG. 27, it was found that impedance matching was well done in the desired frequency band, 76 GHz to 81 GHz, in both of the first case and the second case, and it was found that the bandwidth of the antenna of the second case was wider than that of the first case.

In FIG. 28, a3 shows a peak gain of the first case, a4 shows the peak gain of the second case, a5 shows a peak realized gain of the first case, and a6 shows the peak realized gain of the second case.

Referring to FIG. 28, the maximum gain of the first case was about 6.1 dBi, and the maximum gain of the second case was about 6.7 dBi, and it was found that the second case was improved by about 0.6 dB compared to the first case.

As such, like in the antennas according to the embodiments described herein in which the feeding part was formed adjacent to the first position CP and the center of the feeding part was overlapped with the diagonal D1 of the bottom surface of the dielectric material block passing the first position CP, it was found that the gain of the antenna was improved in the second case.

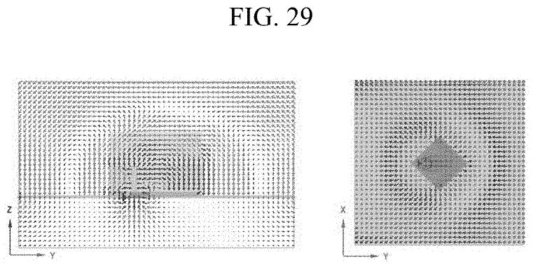

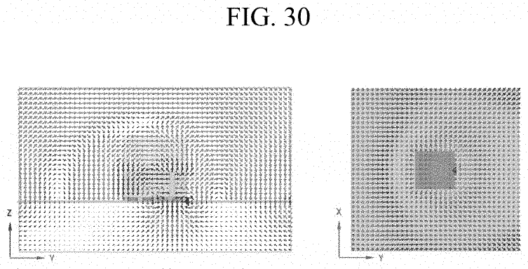

Next, another experimental example is described with reference to FIG. 29 and FIG. 30. FIG. 29 and FIG. 30 are views showing results of another experimental example.

In the experimental example, a dielectric resonator antenna with a volume of 0.95 mm×0.95 mm×0.96 mm was formed, and an electric field distribution was measured and a result thereof is shown for a first case that a feed via was formed adjacent to the center of the edge of the dielectric material block like in the antenna 100a according to the conventional art of FIG. 3 and a second case that a feed via was formed adjacent to a first position and the center of the feed via is disposed to overlap the diagonal of the bottom surface of the dielectric material block passing the first position like in the antennas according to the embodiments described herein. FIG. 29 shows the result of the second case, and FIG. 30 shows the result of the first case.

Referring to FIG. 29 and FIG. 30, like in the antennas according to the embodiments in the second case the feeding part was formed adjacent to the first position CP and the center of the feeding part was overlapped with the diagonal of the bottom surface of the dielectric material block intersecting the first position CP, compared with the first case in which the feed via was formed adjacent to the center of the edge of the dielectric material block like the antenna according to the conventional art, it was found that the electric field distribution was widely and strongly distributed around the antenna.

As such, it was found that the gain of the antenna was improved as the distribution of the electric field was widely and strongly distributed.

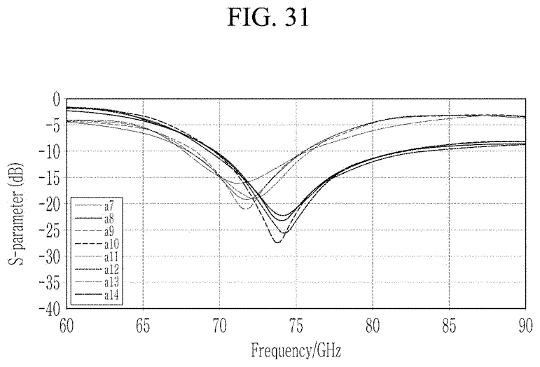

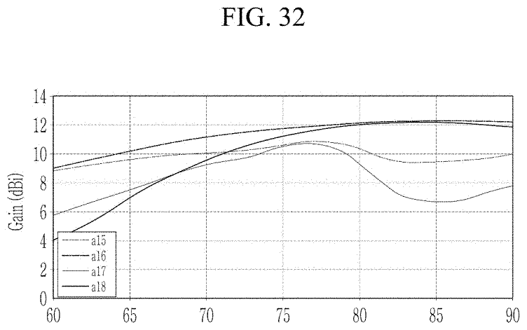

Next, another experimental example is described with reference to FIG. 31 and FIG. 32. FIG. 31 and FIG. 32 are graphs showing results of another experimental example.

In the present experimental example, for a first case in which the feed via is formed adjacent to the center of the edge of the dielectric material block like in the antenna 100a according to the conventional art of FIG. 3 and an antenna module including four antennas arranged at an interval of about 2.23 mm is formed, and a second case in which the feed via is formed adjacent to the first position and the center of the feed via is formed to overlap the diagonal of the bottom surface of the dielectric material block passing the first position like in the antennas according to the embodiments described herein, and an antenna module including four antennas arranged with an interval of about 2.23 mm is formed like the embodiments, an S-parameter was measured and a gain of the antenna module was measured.

The results of the S-parameters in the first case and the second case are shown in FIG. 31, and the results of the antenna module gains of the first case and the second case are shown in FIG. 32. In particular, in FIGS. 31, a7 and a8 show S11, a9 and a10 show S12, a11 and a12 show S21, and a13 and a14 show S22.

In FIG. 31, a7, a9, a11, and a13 show the result of the first case, and a8, a10, a12, and a14 show the result of the second case. Referring to FIG. 31, it was found that the bandwidth of the second case antenna was wider than that of the first case antenna.

In FIG. 32, a15 shows the peak gain of the first case, a16 shows the peak gain of the second case, a17 shows the peak realized gain of the first case, and a18 shows the peak realized gain of the second case.

Referring to FIG. 32, it was found that the maximum gain of the antenna module of the second case was improved by about 1 dBi compared to the antenna module of the first case.

As such, it may be confirmed that the antenna and the antenna module including a plurality of antennas according to the embodiments described herein have a wider bandwidth and a larger gain.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A dielectric resonator antenna comprising:
a dielectric material block extending in a first direction, a second direction different from the first direction, and a third direction perpendicular to the first direction and the second direction; and
a feeding part extending in the third direction from a bottom surface of the dielectric material block to a part of the dielectric material block,
wherein the feeding part overlaps a diagonal, or an extension line of the diagonal, of the bottom surface of the dielectric material block intersecting a first position where a first edge of the bottom surface of the dielectric material block parallel to the first direction and a second edge of the bottom surface of the dielectric material block parallel to the second direction meet.

2. The dielectric resonator antenna of claim 1, wherein a distance between the first position and the feeding part is smaller than a distance between a center of the first edge of the bottom surface of the dielectric material block and the feeding part, and
the feeding part is closer to the first position than to a center of the bottom surface of the dielectric material block.

3. The dielectric resonator antenna of claim 2, wherein the feeding part comprises a feed via extending inside the dielectric material block in the third direction from the bottom surface of the dielectric material block.

4. The dielectric resonator antenna of claim 2, wherein the feeding part comprises a feed strip extending along an outer surface of the dielectric material block in the third direction from the bottom surface of the dielectric material block.

5. The dielectric resonator antenna of claim 4, wherein the feed strip touches the first position and extends in the third direction along a corner of the dielectric material block extending in the third direction.

6. The dielectric resonator antenna of claim 2, wherein the dielectric material block comprises a first dielectric material block, a second dielectric material block stacked on the first dielectric material block in the third direction, and a bonding layer disposed between the first dielectric material block and the second dielectric material block,
a bottom surface of the first dielectric material block is the bottom surface of the dielectric material block, and
the feeding part extends in the third direction from the bottom surface of the first dielectric material block to a part of the first dielectric material block.

7. The dielectric resonator antenna of claim 6, further comprising:
a feed pattern disposed between the first dielectric material block and the second dielectric material block and connected to the feeding part; and
an antenna pattern disposed between the first dielectric material block and the second dielectric material block and coupled to the feed pattern.

8. The dielectric resonator antenna of claim 7, wherein the feeding part comprises a feed via extending completely through the first dielectric material block in the third direction from the bottom surface of the dielectric material block, and
the feed pattern is connected to the feed via.

9. The dielectric resonator antenna of claim 7, wherein the feeding part comprises a feed strip extending along an outer surface of the first dielectric material block in the third direction from the bottom surface of the first dielectric material block, and
the feed pattern is connected to the feed strip.

10. A dielectric resonator antenna module comprising:
a substrate; and
a plurality of dielectric resonator antennas disposed on the substrate,
wherein each of the plurality of dielectric resonator antennas comprises:
a dielectric material block extending in a first direction, a second direction different from the first direction, and a third direction perpendicular to the first direction and the second direction; and
a feeding part extending in the third direction from a bottom surface of the dielectric material block to a part of the dielectric material block,
wherein the feeding part overlaps a diagonal, or an extension line of the diagonal, of the bottom surface of the dielectric material block intersecting a first position where a first edge of the bottom surface of the dielectric material block parallel to the first direction and a second edge of the bottom surface of the dielectric material block parallel to the second direction meet, and
the plurality of dielectric resonator antennas are disposed on the substrate along a line extending in a fourth direction.

11. The dielectric resonator antenna module of claim 10, wherein a distance between the first position and the feeding part is smaller than a distance between a center of the first edge and the feeding part, and
the feeding part is closer to the first position than to a center of the bottom surface of the dielectric material block.

12. The dielectric resonator antenna module of claim 10, wherein the diagonal of the bottom surface of the dielectric material block is parallel to the fourth direction.

13. The dielectric resonator antenna module of claim 12, wherein the feeding parts of the plurality of dielectric resonator antennas are disposed along a line extending in the fourth direction.

14. The dielectric resonator antenna module of claim 10, wherein the diagonals of the bottom surfaces of the plurality of dielectric resonator antennas are substantially perpendicular to the fourth direction.

15. The dielectric resonator antenna module of claim 14, wherein the feeding parts of the plurality of dielectric resonator antennas are disposed along a line extending in the fourth direction.

16. The dielectric resonator antenna module of claim 10, wherein angles between the diagonals of the bottom surfaces of the plurality of dielectric resonator antennas and the fourth direction are less than 90 degrees.

17. The dielectric resonator antenna module of claim 16, wherein the feeding parts of the plurality of dielectric resonator antennas are disposed along a line extending in the fourth direction.

18. A dielectric resonator antenna comprising:
a dielectric material block extending in a first direction, a second direction different from the first direction, and a third direction perpendicular to the first direction and the second direction; and
a feeding part contacting the dielectric material block and extending in the third direction,
wherein the feeding part is closer to a first position where a first edge of a bottom surface of the dielectric material block parallel to the first direction meets a second edge of the bottom surface of the dielectric material block parallel to the second direction than to a center of the first edge of the bottom surface of the dielectric material block, a center of the second edge of the bottom surface of the dielectric material block, and a center of the bottom surface of the dielectric material block.

19. The dielectric resonator antenna of claim 18, wherein the second direction is perpendicular to the first direction,
the dielectric material block has six surfaces, and
each of the six surfaces is a square or a rectangle.

20. The dielectric resonator antenna of claim 18, wherein the feeding part comprises a feed via disposed inside the dielectric material block and extending in the third direction.

21. The dielectric resonator antenna of claim 20, wherein the feed via extends in the third direction from the bottom surface of the dielectric material block and overlaps a diagonal of the bottom surface of the dielectric material block intersecting the first position.

22. The dielectric resonator antenna of claim 18, wherein the feeding part comprises a feed strip disposed on an outside surface of the dielectric material block and extending in the third direction.

23. The dielectric resonator antenna of claim 22, wherein a bottom surface of the feed strip touches the first position and overlaps an extension line of a diagonal of the bottom surface of the dielectric material block intersecting the first position, and
the feed strip extends in the third direction along a corner of the dielectric material block extending in the third direction and overlaps two surfaces of the dielectric material block meeting at the corner.
